(19) United States
(12) Patent Application Publication
(10) Pub. No.: US 2005/0289530 A1
(43) Pub. Date: Dec. 29, 2005

(54) Scheduling of instructions in program compilation

(76) Inventor: Arch D. Robison, Champaign, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,030

(22) Filed: Jun. 29, 2004

(51) Int. Cl. G06F 9/45

(52) U.S. Cl. 717/159; 717/161

(57) ABSTRACT

A method and apparatus for scheduling of instructions for program compilation are provided. An embodiment of a method comprises placing a plurality of computer instructions in a plurality of priority queues, each priority queue representing a class of computer instruction; maintaining a state value, the state value representing any computer instructions that have previously been placed in a instruction group; and identifying one or more computer instructions as candidates for placing in the instruction group based at least in part on the state value.

### FIELD

An embodiment of the invention relates to computer operations in general, and more specifically to scheduling of instructions in program compilation.

### BACKGROUND

In computer operations, a process of translating a higher level programming language into a lower level language, particularly machine code, is known as compilation. One aspect of program compilation that can require a great deal of computing time and effort is the scheduling of instructions. Scheduling can be particularly difficult in certain environments, such as in an architecture utilizing VLIW (very long instruction word) instructions. In addition, the complexity of program scheduling is also affected by processor requirements that affect the order and tempo of instruction scheduling. Conventional systems thus often invest a great deal of processing overhead in creating optimal instruction scheduling.

However, in certain instances, there may be a great desire for speed of compilation as well as nearly optimal scheduling. For example, in engineering and system design, the time spent for numerous compilations of modified code can significantly slow progress and increase costs. Therefore, conventional compilation methods may require excessive time and effort to achieve results that are actually beyond what is needed under the circumstances.

### BRIEF DESCRIPTION OF THE DRAWINGS

The invention may be best understood by referring to the following description and accompanying drawings that are used to illustrate embodiments of the invention. In the drawings:

FIG. 1 illustrates an embodiment of a instruction scheduling system;

FIG. 2 illustrates an embodiment of a process for scheduling of instructions;

FIG. 3 is a flow chart to illustrate an embodiment of scheduling of instructions;

FIG. 4 is a flow chart to illustrate an embodiment of packing of instructions;

FIG. 5 illustrates pseudo-code for an embodiment of a scheduling process;

FIG. 6 illustrates pseudo-code for an embodiment of procedures used in scheduling;

FIG. 7 illustrates pseudo-code for an embodiment of an advance clock procedure;

FIG. 8 illustrates pseudo-code for a first portion of an embodiment of a procedure for instruction packing;

FIG. 9 illustrates pseudo-code for a second portion of an embodiment of a procedure for instruction packing; and

FIG. 10 illustrates an embodiment of a computer system to provide instruction scheduling.

### DETAILED DESCRIPTION

A method and apparatus are described for scheduling of instructions in program compilation.

Before describing an exemplary environment in which various embodiments of the present invention may be implemented, some terms that will be used throughout this application will briefly be defined:

As used herein, “deterministic finite automaton”, “deterministic finite-state automaton”, or “DFA” means a finite state machine or model of computation with no more than one transition for each symbol and state.

As used herein, “directed acyclic graph” or “DAG” means a directed graph that contains no path that starts and ends at the same vertex.

As used herein, “very long instruction word” or “VLIW” means a system utilzing relatively long instruction words, as compared to systems such as CISC (complex instruction set) and RISC (reduced instruction set computer), and which may encode multiple instructions into a single operation.

According to an embodiment of the invention, the compilation of a program includes fast scheduling of instructions. In one embodiment of the invention, instructions being scheduled may include VLIW (very long instruction word) instructions. According to an embodiment of the invention, a compiler includes fast scheduling of VLIW instructions. An embodiment of the invention may include scheduling of instructions for an EPIC (explicitly parallel instruction computing) platform.

Under an embodiment of the invention, a system includes a finite automaton generator such as a deterministic finite automaton (DFA) generator, an instruction scheduler, and an instruction packer. The DFA generator generates a DFA, which is used by the instruction scheduler and the instruction packer in the compilation of a program.

Under an embodiment of the invention, a directed acyclic graph (DAG) of program instructions is built for use in backwards scheduling. The DAG includes nodes and dependencies, including flow, anti, and output dependencies. A node of a DAG may be a real instruction or may be a dummy node representing a pseudo-operation.

Under an embodiment of the invention, once all successors of an instruction have been scheduled, as provided in the DAG, the instruction is moved to a clock queue (referred to as “clock_queue”). Once timing constraints have been satisfied for an instruction, it is moved from the clock queue to a priority queue (“class_queue[i]”). The priority queue is one of multiple priority queues, with each queue holding instructions of a certain class and with instructions in each class having similar resource restraints.

Under an embodiment of the invention, a scheduler maintains a DFA state. The DFA state indicates which instruction classes have been stuffed in the current bundles being worked on, and what instruction group in such bundle is being stuffed currently. The DFA state is used to make a quick determination regarding which instruction should be stuffed next. Under an embodiment of the invention, the DFA state is used to is used to determine what instruction classes are eligible. The determination may include generating a DFA mask, which maps the DFA state onto a bit mask. In such bit mask, a bit i is set if an instruction of class i can be stuffed into the current instruction group in the current bundle. In addition, the scheduler maintains data regarding instruction availability, which may be in the form of a “queue_mask”, for which bit i is set if class_queue[i] is non-empty. Under an embodiment of the invention, the data regarding eligible classes is combined with the data regarding available instructions to produce candidates for scheduling. For example, a bitwise-AND of DFA_Mask [DFA_State] and queue_mask yields a bit mask specifying which priority queue contain instructions that might be stuffed into the current instruction group of the current bundle. In one embodiment, the highest priority instruction from these queues is chosen and transferred to the current instruction group.

Under an embodiment of the invention, a DFA consists of a set of tables that describe the DFA's states and transitions. In this embodiment, each kind of instruction is classified as belonging to one of a number of instruction classes, with instructions in the same class exhibiting similar resource usage. In one particular example, an Intel Itanium 2 processor may have eleven instruction classes. Possible instruction classes and example instructions for an Intel Itanium 2 are illustrated in Table 1.

TABLE 1

| Instruction Class | Instruction Example for Itanium 2 |
|---|---|
| I0 | constant left shift |
| I0\|I1 | variable left shift |
| M0 | memory fence |
| M2 | move to/from application register |
| M0\|M1 | integer load |
| M2\|M3 | integer store |
| M0\|M1\|M2\|M3 | floating-point load |
| F0\|F1 | floating-point multiply-add |
| B | branch |
| L | move long constant into register |
| I0\|I1\|M0\|M1\|M2\|M3 | integer add |

Under an embodiment of the invention, a DFA is based on instruction classes, as opposed to templates or functional units. The use of instruction classes allows certain uses of class properties for efficient instruction scheduling. For example, in an Intel Itanium 2 processor, a “load integer” instruction may use either port M0 or port M1. Under an embodiment of the invention, a single transition type may be utilized for instructions sharing operation features. In one example, a transition type “M0|M1” may be used to model the use of either “M0” or M1”, and thus an integer load instruction may be classified as “M0|M1”.

Under an embodiment of the invention, a generated DFA is a “big DFA” (i.e., originally not minimized) that has been subjected to classical DFA minimization. Each “big DFA” state corresponds to a sequence of multi-sets of instruction classes and a template assignment. Each multi-set represents a set of instructions that can execute in parallel on the target machine. The sequencing represents explicit stops. The template assignment for such instructions is a sequence of zero or more templates that can hold the instructions.

In an example using the instruction classes shown in Table 1, one possible state is “{M0|M1,I0,|I1};{I0}”. This example state represents an instruction group containing two instructions, one instruction being in class M0|M1 and one instruction being in class I0|I1, followed by an instruction group holding one instruction in class I0. In an embodiment, the sequence items are multisets, as opposed to sets. For example, the state “{M0|M1, M0|M1};{I0}” is distinct from the state “{M0|M1};{I0}”. Under an embodiment of the invention, states are created only if such states can be efficiently implemented by a template without incurring any implicit stalls.

Under an embodiment of the invention, states are generated in two phases. In a first phase, all possible template/class combinations for a certain number of bundles (such as zero to two bundles) that do not stall without any nops (no operation instructions), and that do not have a stop at the end of any bundle. Such states are termed “maximal states”. For each maximal state, substates may be generated by recursively removing items from the multisets. In one possible example, the maximal state “{M0|M1} {I0|I1};{I0}” yields the following set of substates:

| | | |
|---|---|---|
| “{I0\|I1};{I0}” | “{M0\|M1};{I0}” | “{M0\|M1,I0\|I1};{}” |
| “{I0\|I1};” | “{};{I0}” | “{M0\|M1};{}” |
| “{};{}” | | |

Under an embodiment of the invention, a DFA is used for guiding a backwards list scheduler. Under another embodiment of the invention, a forward scheduler may be utilized. The situation for a forwards list scheduler is essentially a mirror image of the backwards scheduler, and thus application to forward schedulers can be accomplished by those skilled in the art of scheduling without great difficulty. In a backwards scheduler, the transitions relate to prepending instructions. There are transitions from a state “S” to a state “T” for the following cases:

(1) Prepending an instruction to the sequence—A state transition denoted Transition (S, C)=T, from state S to state T via instruction class C is added if state T is the same as state S with C added to the first multiset.

(2) Prepending a stop bit in the middle of a bundle—A state transition denoted Midstop(S)=T is added if S is maximal and the first multiset in S in non-empty, and T is the same as state S with an empty multiset prepended.

(3) Emitting bundle(s) with the first group of instructions deferred to the next bundle—A state transition denoted Continue(S)=T is added if the sequence for S contains more than one multiset, and the first multiset is non-empty.

Under an embodiment of the invention, a sequence of templates is associated with each DFA state. Such templates are used for encoding the instructions in the state. For example, the state “{M0|M1, I0|I1};{I0}” would have the associated template “MI;I” for encoding the instructions in the state.

Under an embodiment of the invention, classical DFA minimization is applied to a big DFA to shrink it. The minimization process yields a DFA that, for a given sequence of transitions, rejects the transitions or reports the final template sequence identically to the operation of the big DFA. For example, in one example a processor has a big DFA with 75,275 states, of which 62,650 are reachable states. In contrast, the minimized DFA has 1,890 states. In one embodiment, further compression is achieved by observing that many of the states are terminal states with no instruction-class transitions from them, and thus these states do not require any rows in the main transition table DFA_Transistion. In this example, the main transition table is left with only 1,384 states. The final tables generated for the minimized DFA, which are used by the scheduler, are:

| | |
|---|---|
| DFA_Transition[state, class] | Similar to “Transition”, but for minimized |
| | DFA |
| DFA_Midstop[state] | Similar to “Midstop”, but for minimized |
| | DFA |
| DFA_Continue[state] | Similar to “Continue”, but for minimized |
| | DFA |
| DFA_Mask[state] | Bit i is set if and only if there is transition |
| | from the given state via class i |
| DFA_Packing[state] | Template sequence to be used to encode |
| | instructions |

Because certain DFA states may be encoded by more than template, an embodiment of the invention may provide additional reduction in DFA size beyond that which is achieved by conventional DFA minimization. In a big DFA, a maximal state may cover many possible multiset sequences. In one example, a state with a template “MMI” covers both {M0|M1, M0|M1, I0} and {M0|M1, M0|M1, I0|I1}, as well as many other cases. Under an embodiment of invention, when building a big DFA, all possible maximal states are generated, and then a standard “greedy algorithm” for minimum-set-cover is run to find a minimum or near minimum number of maximal states that will cover all multiset sequences of interest.

Under an embodiment of the invention, instruction groups are treated as being generally unordered, except that branches are placed at the end of a group. Because, for example, an Itanium processor generally permits write-after-read dependencies but not read-after-write dependencies in an instruction group, the scheduler does not allow instructions with anti-dependencies to be scheduled in the same group. Anti-dependencies are sufficiently rare that while important to handle for optimal scheduling, may not be critical to a fast scheduler that writes less than optimal coding (“pretty good code”.) Under an embodiment of the invention, the end of group rule for branches exists so that the common read-after-write case, which is allowed by processors such as the Intel Itanium, via setting a predicate and using it in a branch that can be exploited by the scheduler.

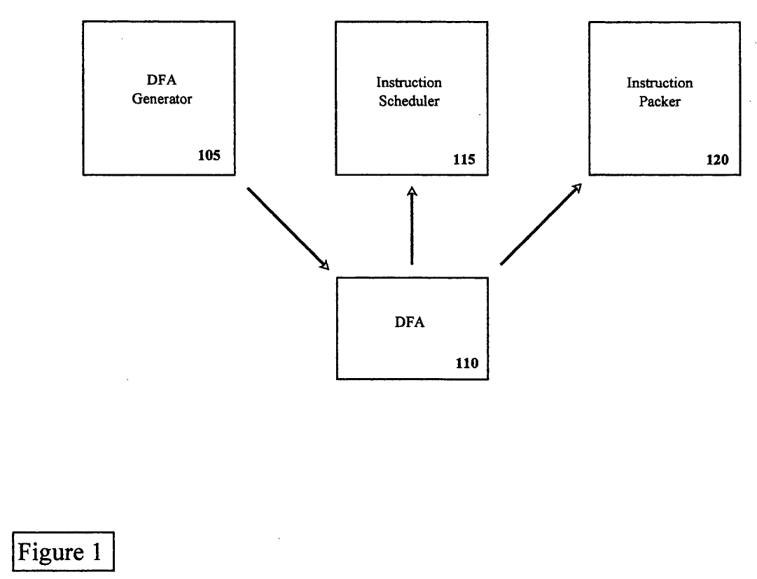

FIG. 1 is an illustration of an embodiment of an instruction scheduling system. In an embodiment of the invention, a DFA generator 105 operates when a program compiler is built. The DFA generator 105 generates a DFA 110 for use in scheduling. Under an embodiment of the invention, the DFA 110 is used by an instruction scheduler 115 and by an instruction packer 120 when a program is compiled. In the embodiment, the DFA is used to produce information regarding eligible instructions, such as by producing a mask of instructions that can be scheduled. The DFA is further used to provide templates for instructions as such instructions are packed.

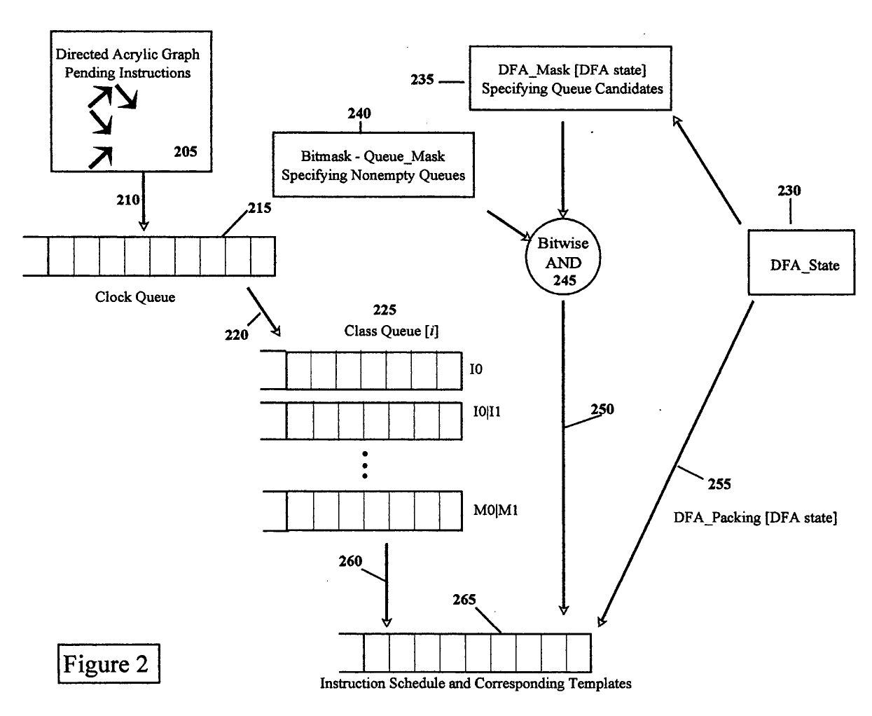

FIG. 2 is an illustration of a process for scheduling and packing instructions. Under an embodiment of the invention, the instructions may comprise VLIW instructions. In this illustration, a directed acrylic graph (DAG) is produced of pending instructions 205. As all of the successors to an instruction are scheduled, the instruction is moved 210 into a clock queue 215. Each such instruction remains in the clock queue 215 until the starting time for the instruction is reached, as which time the instruction is moved 220 into one of a plurality of class queues 225. Each class queue represents a class of instruction. Under one embodiment of the invention, the class queues represent the classes of instructions for an Intel Itanium processor, as shown in Table 1 above.

In FIG. 2, a DFA state 230 is maintained, with the current state representing the instructions that have previously been packed. For example, if a current group is being packed for a certain bundle, the DFA state 230 may represent the instructions that have already been packed into the current group. The DFA state 230 is used to produce a DFA mask for the current state, which may be represented as DFA_Mask[DFA State]. The output of the DFA_Mask function is a mask that specifies which class queues are eligible for scheduling. Also produced is a bitmask designated as Queue_Mask, which represents which of the class queues currently contain instructions, i.e., are non-empty. In this embodiment, a bitwise AND operation 245 is applied to the DFA_Mask 235 and to the Queue_Mask 240, thereby identifying the instructions that are available candidates for scheduling 250. Utilizing such information, from the instructions contained in the eligible queues of the class queues 225, the instruction with the highest priority is sent to the instruction schedule 265. Further the current DFA state 230 is used to chose the appropriate template for the instruction, shown as DFA_Packing[DFA_State] 255.

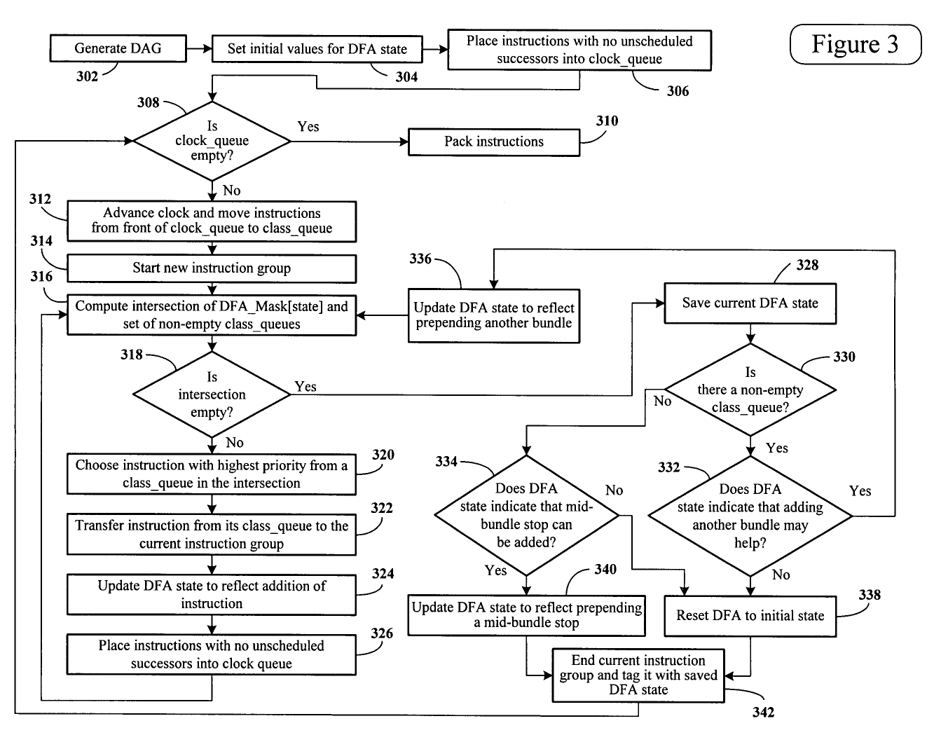

FIG. 3 is a flow chart to illustrate an embodiment of a process for scheduling instructions. Under an embodiment of the invention, a directed acyclic graph of pending instructions is generated 302. Initial values are set for a DFA state 304. Instructions that have no unscheduled successor are placed in a clock_queue 306. There is a determination whether at this point the clock_queue is empty 308. If the queue is empty, then the instructions are packed 310. If the clock_queue is not empty, the clock is advanced and the instructions at the front of the clock queue are moved into appropriate class_queues 312, with each class queue representing a class of instruction.

A new instruction group is started 314. The intersection between a mask of the eligible instructions for the current state (DFA_Mask[state]) and the set of class_queues that are non-empty is computed to identify available instructions scheduling 316. If the intersection is not empty 320 and thus there are one or more instructions for scheduling, the instruction with the highest priority in a class_queue in the intersection is chosen 320. The instruction is transferred from the class_queue to the current instruction group 322. The DFA state is updated to reflect the addition of the instruction 324. Any instructions that at this point have no unscheduled successors are placed in the clock_queue 326, and the process returns to the computation of the intersection of DFA_Mask[state] and the set of non-empty class_queues 316.

If there is a determination that the intersection is empty 318, the current DFA state is saved 328. If there is then a non-empty class_queue, then there is a determination whether the DFA state indicates that adding another bundle may help 332. If adding another bundle may help, the DFA state is updated to reflect prepending another bundle 336 and the process returns to the computation of the intersection of DFA_Mask[state] and the set of non-empty class_queues 316. If adding another bundle would not help, the DFA is reset to the initial state 338 and the current instruction group is ended and tagged with the saved DFA state 342. The process is then returns to the determination whether the clock_queue is empty 308. If the clock_queue is not empty 330, then there is determination whether the DFA state indicates that a mid-bundle stop can be added 340. If a mid-bundle stop can be added, then the DFA state is updated to reflect prepending a mid-bundle stop 340, and the current instruction group is ended and tagged with the saved DFA state 342. If a mid-bundle stop cannot be added 334, the process continues with resetting the DFA to the initial state 338.

A key feature is that instruction packing iterates over the instruction groups in the reverse order in which they were created. This is necessary because sometimes the scheduler will tentatively decide on a particular template for a sequence of instruction groups, but when it schedules a preceding group, it may change its decision about the template for the later group, which in turn may change in a cascading fashion its decision about the group after that. By scheduling the instructions in reverse order, and packing them in forward order, the tentative decisions are overridden on the fly in an efficient manner.

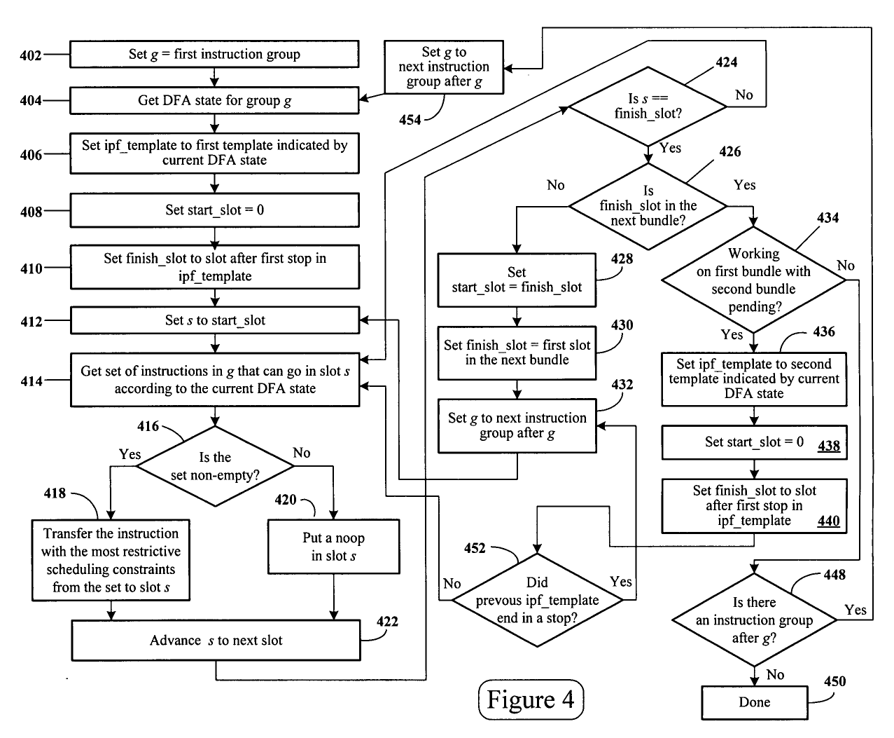

FIG. 4 is a flow chart to illustrate an embodiment of packing of instructions. In this illustration, a variable g is set to the first instruction group 402. The DFA state for group g is obtained 404 and an ipf template is set to the first template that is indicated by the current DFA state 406. A value start_slot is set to zero 408 and a value finish_slot is set to the slot after the first stop in the ipf template 410. Value s is set to start_slot 412.

A set of instructions that can go into slot s according to the current DFA state is obtained 414. If the set is non-empty 416, then the instruction with the most restrictive scheduling restraints is transferred from the set to slot s 418 and s is advanced to the next slot 422. If the set is empty 416, a nop (no operation) instruction is placed in slot s 420 and s is advanced to the next slot 422.

After advancement of the slot, there is determination whether s equals the value finish_slot 424. If not, the process returns to obtaining a set of instructions that can go into slot s according to the current DFA state 414. If the s is not equal to finish_slot 424, then there is determination whether finish_slot is in the next bundle 426. If not, then set_slot is set to the value of finish_slot 428, finish_slot is set to the first slot in the next bundle 430, and g is advanced to the next instruction group 432. The process then returns to setting s to start_slot 412.

If finish_slot is not in the next bundle 426, then there is determination whether the process is working on a first bundle with a second bundle pending 434. If the process is working on a first bundle with a second bundle pending, then the ipf template is set to the second template indicated by the current DFA state 436. Start_slot is set to zero 438, and finish_slot is set to the slot after the first stop in the ipf template 440. If the previous ipftemplate ended in a stop 452, then the process returns to setting g to the next instruction group after g 432. If the previous ipf template did not end in a stop 452, then the process returns to obtaining a set of instructions that can go into slot s according to the current DFA state 414.

If the process is not working on a first bundle with a second bundle pending 434, then there is a determination whether there is an instruction group after g 448. If there is another group after g, then g is set to the next instruction group 454 and the process continues with obtaining the DFA state for group g 404. If there is not another group after g, then the process is completed 450.

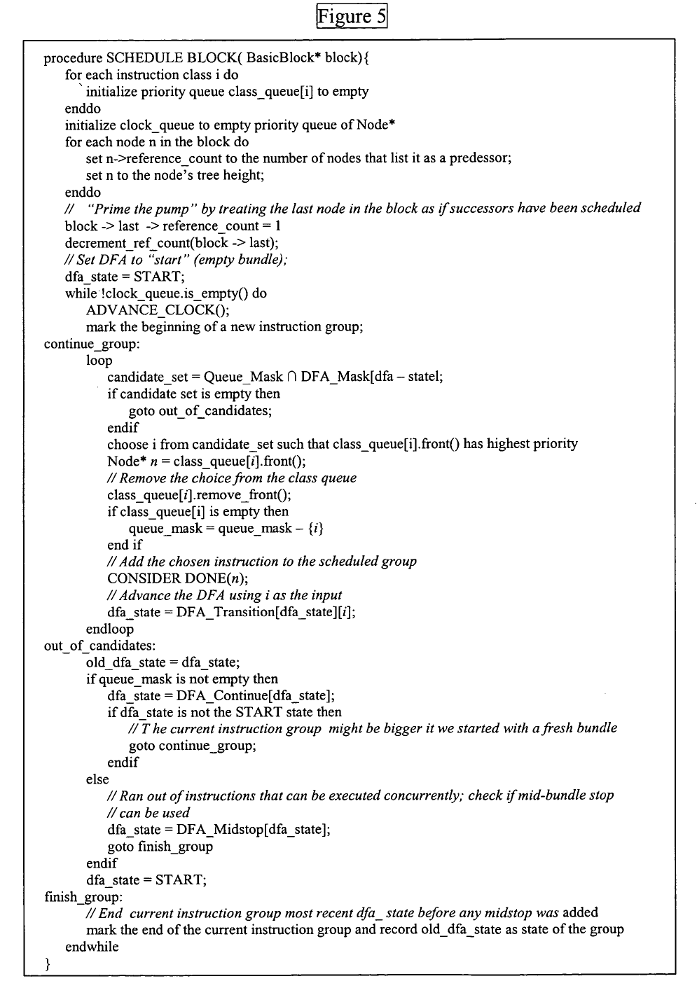

FIG. 5 illustrates pseudo code for an embodiment of a scheduling process. In this illustration, a procedure SCHEDULE_BLOCK schedules instructions in a basic block. In one embodiment, the instructions comprise VLIW instructions. A clock_queue holds instructions for scheduling. Under an embodiment of the invention, an instruction is placed in the clock-queue when all successors to the instruction have been schedule. A main “while” loop runs until the clock queue runs out of instructions.

In FIG. 5, a procedure ADVANCE_CLOCK then transfers instructions from the clock_queue to a plurality of class_queue, with each of the class_queues representing one class of instruction and with each instruction being transferred at the appropriate time to the class_queue that represents the class of such instruction. A queue mask indicates which class_queues are non-empty and is updated incrementally. Back in SCHEDULE_BLOCK, a DFA mask indicates which classes of instructions have been scheduled. An inner loop uses queue_mask and DFA_Mask[dfa_state] to determine the candidate priority queues to search. The inner loop then picks the class_queue with the highest_priority top element. In this illustration, the instruction at the front of the chosen queue is removed, with queue_mask being updated if necessary, and such instruction is then added to the current instruction group by the procedure CONSIDER_DONE. The dfa_state then would be updated to reflect the addition of a new instruction. Once there are no more candidates, the process continues in one of the following processes:

1) If class queues have more instructions that can be executed in the current group and won't fit with the current bundles implied by the DFA state, but may be profitably be made part of the next bundle (as decided by determining whether DFA_Continue[dfa_state] is START)—The scheduler continues building the instruction group.

2) If the class_queues run out of instructions, indicating that the end of an instruction group has been reached—In such case, it may be profitable to prepend a mid-bundle stop. The dfa_state is updated to be DFA_Midstop[dfa_state]. It a mid-bundle stop is not profitable, DFA_Midstop[dfa_state] is simply START. The DFA state for the instruction group is set as the state before the stop was added. If a mid-bundle stop is not profitable, the pre-stop state is the state that will be used by the instruction packer. If the mid-bundle stop turns out to be profitable, then the packer will ignore the DFA state of the current group because it will be using the DFA state for the group at the start of the bundle to guide packing. I.e., the scheduler is working backwards, and leaving a trail of alternative packings. The packer works forwards, and skips alternatives subsumed by earlier alternatives.

3) If neither condition 1 or condition 2 holds, then the DFA is reset, and the DFA state just before the reset becomes the state for the instruction group.

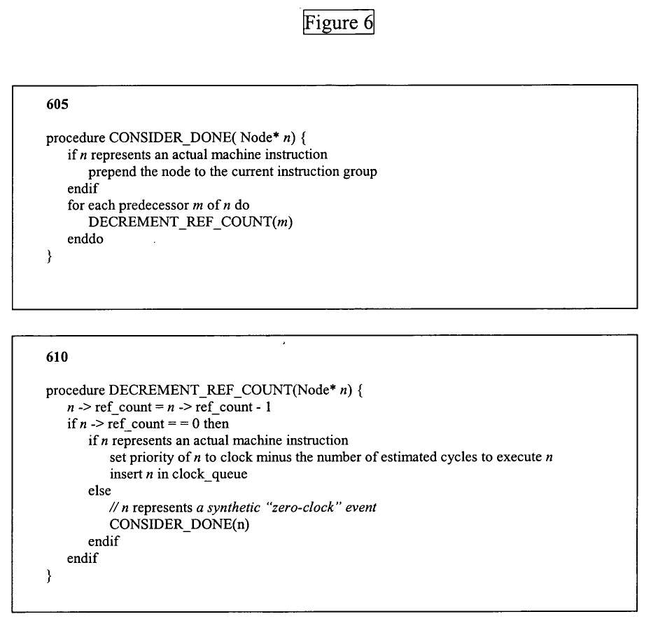

FIG. 6 illustrates pseudo-code for an embodiment of procedures used in scheduling. In this embodiment, the procedures are mutually recursive and are invoked by SCHEDULE_BLOCK. A procedure CONSIDER_DONE 605 provides for adding an instruction to a current group, and calls DECREMENT_REF_COUNT 610 to update reference counts. In this embodiment, when a node's reference count reaches zero, the node is added to the clock_queue if the node represents a real instruction. If the node represents mere dependence information, the node is immediately processed by CONSIDER_DONE.

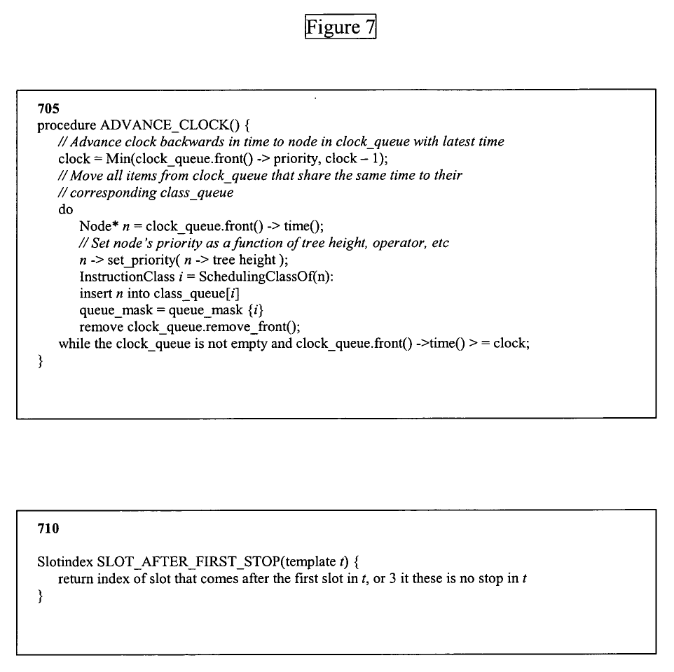

FIG. 7 illustrates pseudo-code for an embodiment of a clock advancing procedure. In this embodiment, the ADVANCE_CLOCK procedure 705 handles the transfer of instructions from the clock_queue to the correct class_queues. Further, the instruction provides for keeping the queue_mask up to date. FIG. 6 also illustrates the procedure SLOT_AFTER_FIRST_STOP 710, which provides an index of a slot in a template and is utilized in instruction packing.

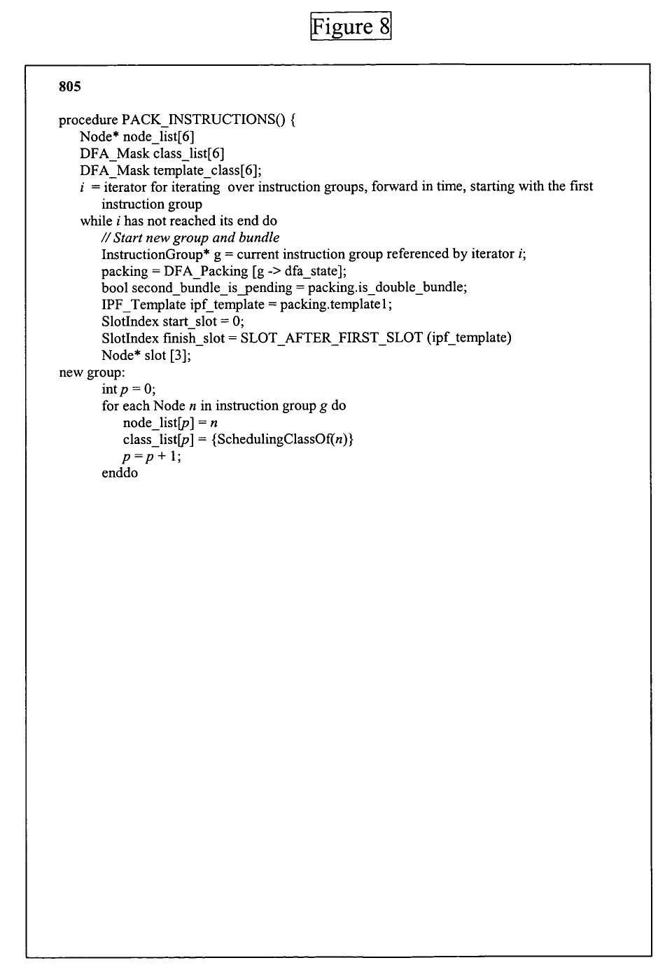

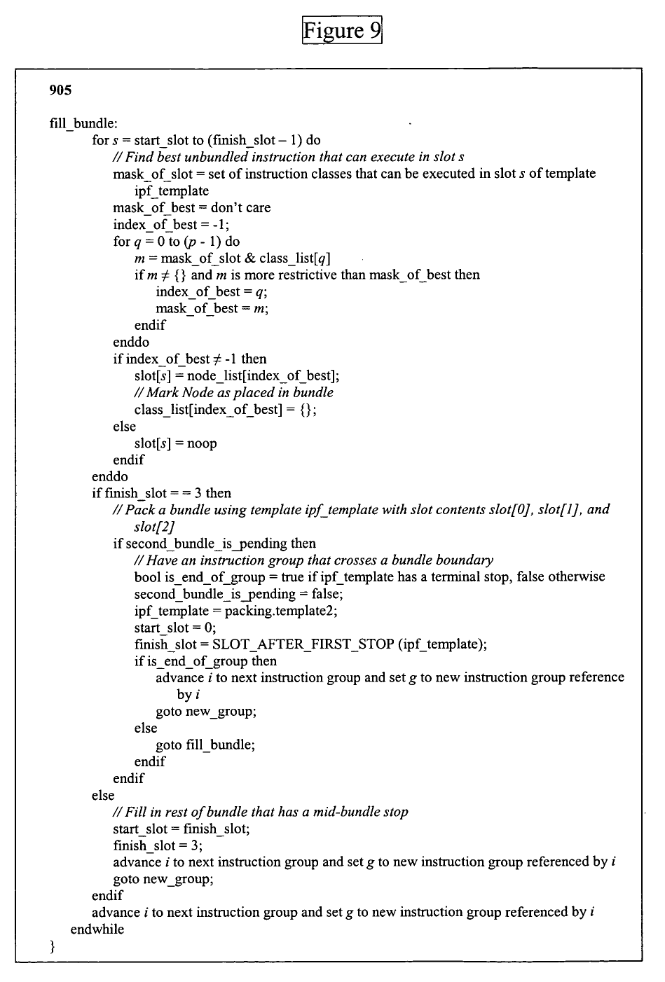

FIG. 8 illustrates pseudo-code for an embodiment of a first portion of an embodiment of a procedure for instruction packing, with the second portion being illustration in FIG. 9. In this illustration, a procedure provides for packing instruction groups into final bundles. Each instruction group has an associated DFA state that describes how to pack the group with zero or more succeeding groups. In this illustration, the beginning of a while loop starts a new group and bundle. At the “new group” point in FIG. 7, a new instruction group (but not necessarily a new bundle) is being packed. The indices start_slot and finish_slot describe a half-open range [state_slot, finish_slot) of slots within the current bundle that are to be filled. An inner loop (“fill_template”) proceeds through such slots, filling the slots with instructions chosen from the current group.

In an embodiment shown in FIGS. 8 and 9, when there is more than one possible choice of instructions, the choice made is the instruction whose class has the most restrictive scheduling. If there are no instructions that fit a slot, then a nop (no operation) instruction is used to fill the slot. The procedure further includes logic for addressing questions regarding whether packing should continue with a second bundle of instructions. In a second bundle, the ipf template is set according to the packing value that is set when a new group and a new template are started. For example, if a scheduler determines that instructions should be packed into a dual-bundle “M;MIMI;I”, then the DFA state of the first instruction group has a DFA_Packing value of “M;MIMI;I”, with the DFA state for the other two groups in the bundle being ignored.

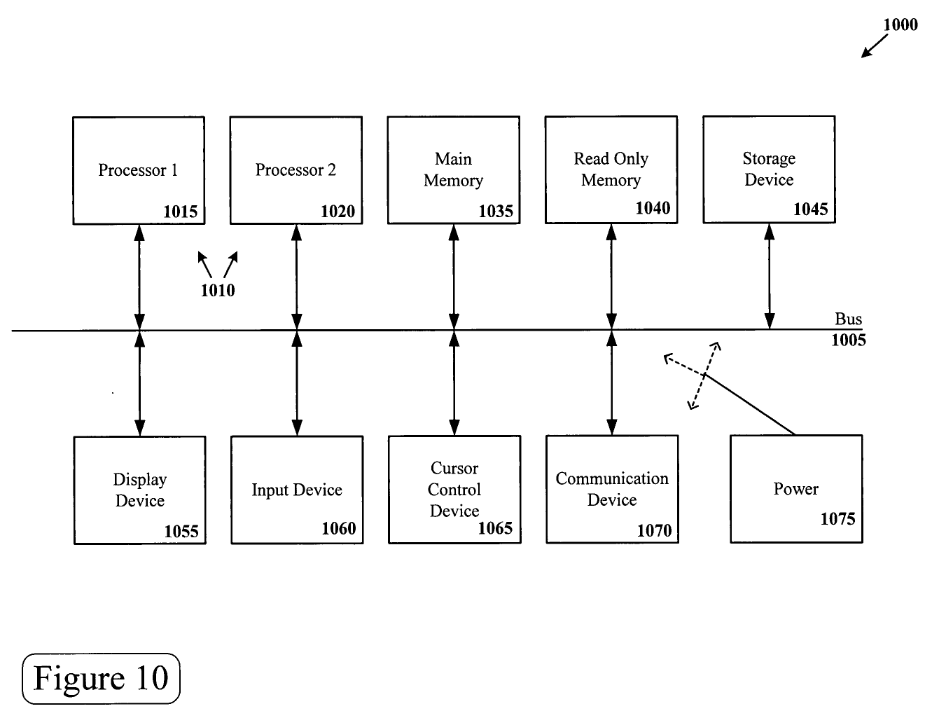

FIG. 10 is block diagram of an embodiment of a computer system to provide instruction scheduling. Under an embodiment of the invention, a computer 1000 comprises a bus 1005 or other communication means for communicating information, and a processing means such as two or more processors 1010 (shown as a first processor 1015 and a second processor 1020) coupled with the first bus 1005 for processing information. The processors may comprise one or more physical processors and one or more logical processors.

The computer 1000 further comprises a random access memory (RAM) or other dynamic storage device as a main memory 1035 for storing information and instructions to be executed by the processors 1010. Main memory 1035 also may be used for storing temporary variables or other intermediate information during execution of instructions by the processors 1010. The computer 1000 also may comprise a read only memory (ROM) 1040 and/or other static storage device for storing static information and instructions for the processor 1010.

A data storage device 1045 may also be coupled to the bus 1005 of the computer 1000 for storing information and instructions. The data storage device 1045 may include a magnetic disk or optical disc and its corresponding drive, flash memory or other nonvolatile memory, or other memory device. Such elements may be combined together or may be separate components, and utilize parts of other elements of the computer 1000.

The computer 1000 may also be coupled via the bus 1005 to a display device 1055, such as a cathode ray tube (CRT) display, a liquid crystal display (LCD), or other display technology, for displaying information to an end user. In some environments, the display device may be a touch-screen that is also utilized as at least a part of an input device. In some environments, display device 1055 may be or may include an auditory device, such as a speaker for providing auditory information. An input device 1060 may be coupled to the bus 1005 for communicating information and/or command selections to the processors 1010. In various implementations, input device 1060 may be a keyboard, a keypad, a touch-screen and stylus, a voice-activated system, or other input device, or combinations of such devices. Another type of user input device that may be included is a cursor control device 1065, such as a mouse, a trackball, or cursor direction keys for communicating direction information and command selections to the one or more processors 1010 and for controlling cursor movement on the display device 1065.

A communication device 1070 may also be coupled to the bus 1005. Depending upon the particular implementation, the communication device 1070 may include a transceiver, a wireless modem, a network interface card, or other interface device. The computer 1000 may be linked to a network or to other devices using the communication device 1070, which may include links to the Internet, a local area network, or another environment. The computer 1000 may also comprise a power device or system 1075, which may comprise a power supply, a battery, a solar cell, a fuel cell, or other system or device for providing or generating power. The power provided by the power device or system 1075 may be distributed as required to elements of the computer 1000.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A method comprising:
placing a plurality of computer instructions in a plurality of priority queues, each priority queue representing a classification of computer instruction;
maintaining a state value, the state value representing any computer instructions that have previously been placed in an instruction group; and
identifying one or more computer instructions as candidates for placing in the instruction group based at least in part on the state value.

2. The method of claim 1, further comprising producing a directed acyclic graph (DAG) of the plurality of program instructions and placing each of the plurality of program instructions in a clock queue as the successors to the program instructions are scheduled.

3. The method of claim 2, further comprising transferring the plurality of computer instructions from the clock queue into the plurality of priority queues.

4. The method of claim 1, wherein the plurality of instructions comprises VLIW (very long instruction word) instructions.

5. The method of claim 1, wherein maintaining a state value comprises maintaining a finite automaton state.

6. The method of claim 5, wherein identifying the one or more computer instructions as candidates comprises generating a first bit mask from a current DFA state.

7. The method of claim 6, wherein identifying the one or more computer instructions as candidates further comprises combining the first bit mask with a second bit mask representing priority queues of the plurality of priority queues that currently contain one or more program instructions.

8. A compiler comprising:
a deterministic finite automaton (DFA) generator, the DFA generator to produce a DFA state representing program instructions that have been packed;
an instruction scheduler, the instruction scheduler to choose instructions for scheduling based at least in part on the DFA state; and
an instruction packer, the instruction packer to provide a template for packing of program instructions based at least in part on the DFA state.

9. The compiler of claim 8, wherein choosing instructions comprises the instruction scheduler to generate a combination of information regarding eligible instructions and information regarding available instructions.

10. The compiler of claim 9, further comprising a plurality of priority queues, each queue representing an instruction classification, the instruction scheduler to choose instructions from the plurality of priority queues.

11. The compiler of claim 10, wherein the information regarding eligible instructions comprises a first bit mask representing instruction classifications that are eligible for packing in a group of instructions.

12. The compiler of claim 11, wherein the information regarding available instructions comprises a second bit mask representing non-empty priority queues.

13. The compiler of claim 12, wherein the combination comprises a result of a bit-wise AND operation for the first bit mask and the second bit mask.

14. A system comprising;
dynamic memory to hold data, the data to include an application to be compiled by the processor; and
a compiler, the compiler comprising:
a deterministic finite automaton (DFA) generator, the DFA generator to produce a DFA state representing program instructions for the application that have been packed,
an instruction scheduler, the instruction scheduler to choose program instructions for scheduling based at least in part on the DFA state, and
an instruction packer, the instruction packer to provide a template for packing of program instructions for the application based at least in part on the DFA state.

15. The system of claim 14, wherein the instruction scheduler is to choose instructions for scheduling by combining information regarding eligible instructions with information regarding available instructions to identify candidates for scheduling.

16. The system of claim 15, wherein the dynamic memory is to include a plurality of priority queues, each priority queue representing an instruction classification, the instruction scheduler to choose instructions for scheduling from the plurality of priority queues.

17. The system of claim 16, wherein the information regarding eligible instructions comprises a first bit mask of instruction classifications that are eligible for packing in a group of instructions.

18. The system of claim 17, wherein the information regarding available instructions comprises a second bit mask representing non-empty priority queues.

19. The system of claim 18, wherein the combination comprises a bit-wise AND operation of the first bit mask and the second bit mask.

20. A method comprising:
placing a plurality of computer instructions in a clock queue;
as a time for each of the plurality of computer instructions is reached, placing each computer instruction in the clock queue in one of a plurality of class queues, each class queue representing a class of computer instruction;
maintaining a deterministic finite automaton (DFA) state representing the classes of computer instruction that have been stuffed into a current bundle;
generating a first mask, the first mask representing which instruction classes may be stuffed into the current group of the current bundle;
generating a second mask, the second mask representing which of the plurality of class queues is non-empty;
performing a bitwise AND operation on the first mask and the second mask; and
placing an computer instruction into the current group of the current bundle, the computer instruction being the highest priority computer instruction that meets the requirements of the bitwise AND operation.

21. The method of claim 20, further comprising producing a directed acyclic graph (DAG) of instructions.

22. The method of claim 21, wherein placing the program instructions in the clock queue comprises transferring an instruction to the clock queue when the DAG indicates that all successors to the instruction have been scheduled.

23. The method of claim 21, further comprising providing a template for packing of instructions based at least in part on the DFA state.

24. A machine-readable medium having stored thereon data representing sequences of instructions that, when executed by a processor, cause the processor to perform operations comprising:
placing a plurality of computer instructions in a plurality of priority queues, each priority queue representing a classification of computer instruction;
maintaining a state value, the state value representing any computer instructions that have previously been placed in an instruction group; and
identifying one or more computer instructions as candidates for placing in the instruction group based at least in part on the state value.

25. The medium of claim 24, wherein the further comprise instructions that, when executed by a processor, cause the processor to perform operations comprising:
producing a directed acyclic graph (DAG) of the plurality of program instructions and placing each of the plurality of program instructions in a clock queue as the successors to the program instructions are scheduled.

26. The medium of claim 25, wherein the further comprise instructions that, when executed by a processor, cause the processor to perform operations comprising:
transferring the plurality of computer instructions from the clock queue into the plurality of priority queues.

27. The medium of claim 24, wherein the plurality of instructions comprises VLIW (very long instruction word) instructions.

28. The medium of claim 24, wherein maintaining a state value comprises maintaining a directed finite automaton (DFA) state.

29. The medium of claim 28, wherein identifying the one or more computer instructions as candidates comprises generating a first bit mask for a current DFA state.

30. The medium of claim 29, wherein identifying the one or more computer instructions as candidates further comprises combining the first bit mask with a second bit mask representing priority queues of the plurality of priority queues that currently contain one or more program instructions.
